(19) United States
(12) Patent Application Publication
(10) Pub. No.: US 2004/0049453 A1
(43) Pub. Date: Mar. 11, 2004

(54) Method and apparatus for receiving and dispensing value carriers

(76) Inventors: Juan-Jose Moreno, Le Mont-sur-Lausanne (CH); Andre Gerlier, Sciez (FR)

Correspondence Address: FISH & RICHARDSON P.C., 45 ROCKEFELLER PLAZA, SUITE 2800, NEW YORK, NY, 10111, US

(21) Appl. No.: 10/250,387

(22) PCT Filed: Dec. 20, 2001
(86) PCT No.: PCT/IB01/02805

(30) Foreign Application Priority Data
Dec. 29, 2000 (EP) 00311777.7

(51) Int. Cl. G06F 17/60

(52) U.S. Cl. 705/39; 705/38

(57) ABSTRACT

Value carriers are validated according to their suitability for recirculation and routed to a two-way store (16) if suitable or to an escrow (14) if not. The two-way store (16) carries value carriers accepted during previous transactions and dispenses the value carriers it received during the current transaction if the transaction is cancelled. In one embodiment, the escrow (16a, 16b) is another two-way store capable of storing value carriers received during previous transactions, thus removing the need for a dedicated escrow. Moreover, the selection of which two-way store is to act as an escrow may vary from one transaction to the next.

### BACKGROUND OF THE INVENTION

The present invention relates to a method and apparatus for receiving, storing and/or dispensing value carriers, preferably including discrimination of paid-in value carriers according to denomination or suitability for recirculation.

U.S. Pat. No. 4,820,909 discloses apparatus for depositing and dispensing banknotes, in which deposited banknotes are validated for authenticity, denomination and suitability for recirculation. Authentic notes which are of high denomination and suitable for recirculation are accumulated in a first temporary store, while authentic notes which are of low denomination or damaged are accumulated in a second temporary store. If the deposit is cancelled, the banknotes are dispensed from the temporary stores. If the deposit proceeds, the contents of the first temporary store are transferred to a cash box and are available for dispensing in subsequent transactions, while the contents of the second temporary store are transferred to a reject box and are not subsequently available for dispensing.

U.S. Pat. No. 4,726,474 discloses apparatus for depositing and dispensing banknotes, in which deposited banknotes which are judged authentic are separated into damaged and undamaged notes and stored in separate parts of a temporary store. Undamaged notes are separated according to denomination and distributed to separate stores, from which they may be paid out in subsequent transactions.

U.S. Pat. No. 4,883,183 discloses apparatus for depositing and dispensing banknotes, in which deposited authentic banknotes are separated according to whether they are damaged and stored in separate temporary stores, from which they are returned to the customer if the transaction is cancelled. If the transaction proceeds, the undamaged banknotes are stored in separate stores according to denomination and can be dispensed in subsequent transactions, while the damaged banknotes are stored in a different store from which they cannot be dispensed.

All of the above apparatus allow recirculation of undamaged banknotes and include a temporary store from which banknotes which have been deposited in a current transaction can be returned if the transaction is cancelled. However, the temporary store is complex as it includes separate stores for damaged and undamaged banknotes.

### STATEMENT OF THE INVENTION

According to one aspect of the present invention, there is provided a method and apparatus for depositing and dispensing value carriers, in which deposited value carriers are validated at least for authenticity and suitability for recirculation. Authentic value carriers which are unsuitable for recirculation are stored in a temporary store or escrow. Authentic value carriers which are suitable for recirculation are stored in one or more long-term stores, together with value carriers deposited in previous transactions, from which they can be dispensed.

If the depositing transaction is confirmed, the value carriers in the escrow are transferred to a permanent store from which they cannot be dispensed, while the value carriers which are suitable for recirculation remain in the one or more long-term stores.

If the depositing transaction is cancelled, the value carriers which are unsuitable for recirculation are dispensed from the escrow. The value carriers which are suitable for recirculation and which have been deposited during the current transaction are dispensed directly from the one or more long-term stores, or may be transferred to the escrow and then dispensed together with the value carriers which are unsuitable for recirculation.

An advantage of the present invention is that value carriers may be sorted according to suitability for recirculation when they are validated for authenticity, but there is no need for multiple temporary stores or escrows. Instead, the one or more long-term stores also serve as temporary stores for notes which are suitable for recirculation.

In an alternative embodiment, one or more of the long-term stores is used as a temporary escrow and there is no need to provide an escrow separate from the long-term stores. The long-term store used as a temporary escrow may vary between transactions.

According to another aspect of the present invention, there is provided a method and apparatus for receiving and storing value carriers, in which a store storing value carriers received during previous transactions is used as an escrow for at least some of the value carriers received during the current transaction, and at least some of the value carriers stored in the escrow are transferred to another store if the current transaction is completed. The escrow may be used to store value carriers which are judged unsuitable for recirculation, in which case these value carriers are transferred to a one-way store if the transaction is completed.

### BRIEF DESCRIPTION OF THE DRAWINGS

Specific embodiments of the present invention will now be described with reference to the accompanying drawings, in which:

FIG. 1 is a schematic diagram of a banknote depositing and dispensing apparatus in a first embodiment of the present invention;

FIG. 2 is a flowchart of a depositing operation of the apparatus of FIG. 1;

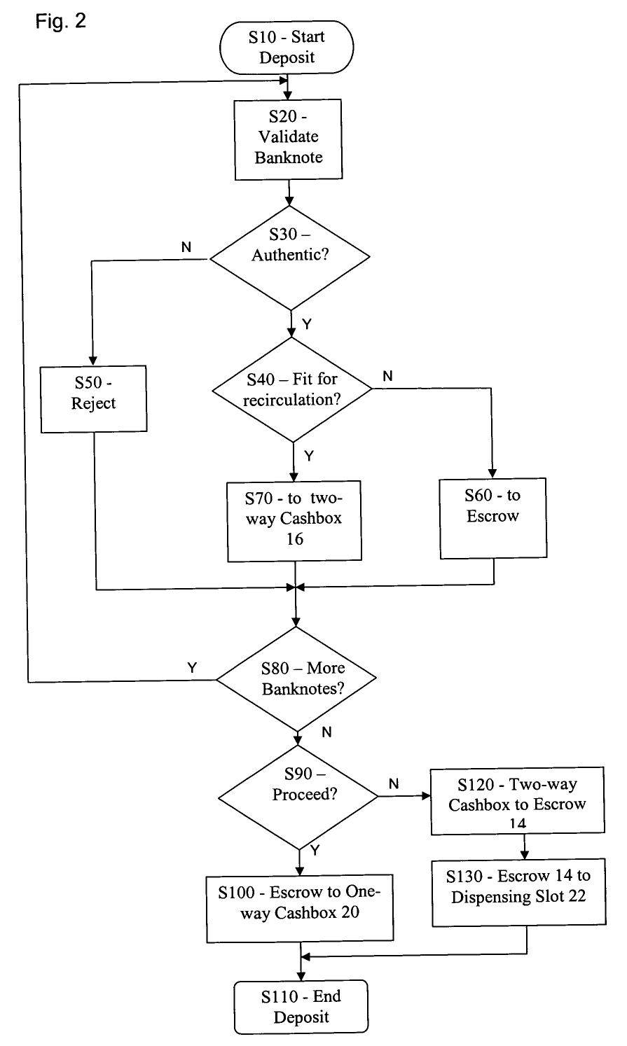

FIG. 3 is a schematic diagram of a banknote depositing and dispensing apparatus in a second embodiment of the present invention;

FIG. 4 is a flowchart of a depositing operation of the apparatus of FIG. 3;

FIGS. 5a and 5b illustrate a method according to a first alternative of the second embodiment;

FIGS. 6a to 6d illustrate a method according to a second alternative of the second embodiment;

FIGS. 7a to 7e illustrate a method according to a third alternative of the second embodiment;

FIGS. 8a and 8b illustrate a method according to the second alternative when applied to the same situation as that of the method of FIGS. 7a to 7e;

FIGS. 9a to 9d illustrate a method according to the second alternative when applied to a variation of the situation illustrated in FIGS. 8a and 8b; and

FIG. 10 is a cross-sectional diagram of a more specific example of the second embodiment.

### MODES FOR CARRYING OUT THE INVENTION

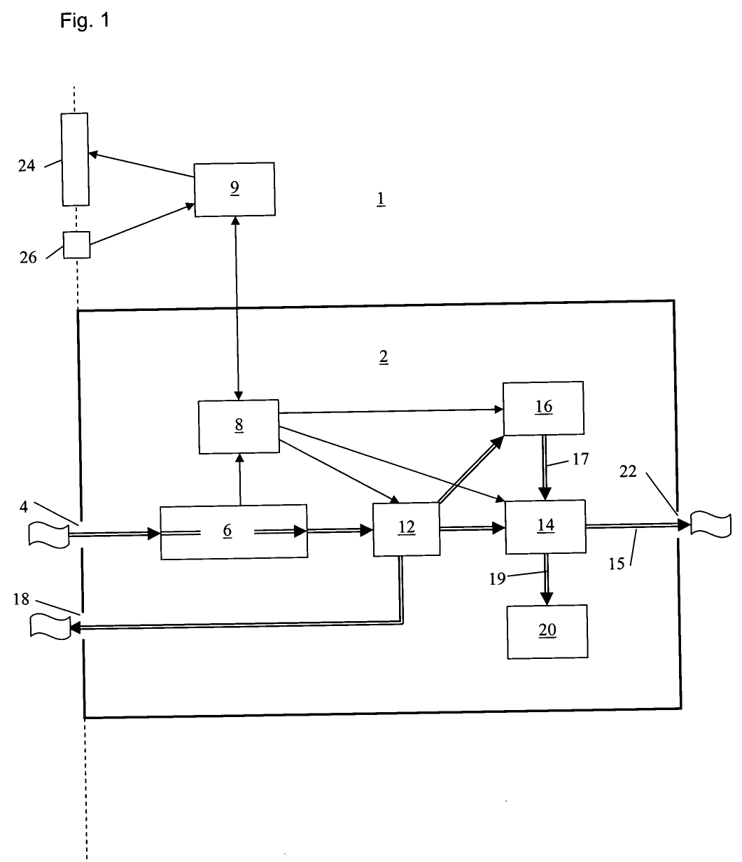

FIG. 1 shows a banknote receiving and dispensing apparatus 2, which may form part of a machine 1, such as an automatic banking machine or a vending machine, in a first embodiment of the present invention. Thick arrows represent bank note transport paths, which may be constructed of any suitable transport means. Thin arrows represent the transmission of signals, by any suitable transmission means. The operation of the receiving and dispensing apparatus 2 is controlled by a validator controller 8, while the functions of the machine as a whole are controlled by a host controller 9 which is connected for duplex communication with the validator controller 8.

A depositing operation is initiated (step S10), for example by detecting the presence of one or more banknotes in a receiving slot 4 or by receiving input from a user through an input device 26. Banknotes are inserted by a user into the receiving slot 4 and are transported one by one by suitable transport means to a validator 6 (step S20).

The validator 6 measures parameters of each banknote and inputs them to the validator controller 8, where each parameter is compared against a predetermined tolerance range for that parameter. Some of the parameters are used to judge authenticity and denomination of the banknote, while others are used to judge the condition of the banknote. For example, parameters used to judge authenticity and denomination may include the spectrum and/or spatial variation of light reflected by or transmitted through a banknote, or the change in a magnetic field produced by a banknote printed with magnetic ink. Parameters used to judge condition may include the overall or partial transmittance or reflectance of the banknote, irregularity of the edge of the note, or the presence of adhesive tape. A narrower acceptance range of a parameter may be applied for dispensing banknotes than for receiving them, as disclosed in EP-A-706698.

If the banknote is judged authentic (step S30), the validator controller 8 also determines whether the banknote is fit for recirculation (step S40). Banknotes may be judged fit for recirculation if they are in good condition and/or of a denomination that is suitable for recirculation. If the machine 1 is a vending machine which recirculates banknotes as change, high denomination banknotes in good condition may be judged unsuitable for recirculation. Conversely, if the machine 1 is an automatic banking machine which recirculates banknotes as a cash withdrawal, low denomination banknotes may be judged unsuitable for recirculation.

The validator controller 8 outputs a control signal to a router 12 to direct the banknote to a reject slot 18 if the banknote is not genuine (step S50), to an escrow 14 if the banknote is genuine but not suitable for recirculation (S60), or to a two-way cashbox 16 if the banknote is genuine and suitable for recirculation (S70). If more than one denomination is to be handled, one two-way cashbox 16 may be provided for each denomination which is suitable for recirculation, and the router 12 directs each banknote to one of the two-way cashboxes 16 according to its determined denomination. Alternatively, multiple different denominations may be stored in a single two-way cashbox 16, as described for example in GB-A-2360385.

The escrow 14 may be, for example, a drum escrow of the type described in WO 96/15511.

The host controller 9 receives a signal from the validator controller 8 indicating the value of banknotes accepted as genuine in the current transaction; this may be displayed to the user on a display unit 24. The user may reinsert any rejected banknotes for revalidation. Each banknote present in the receiving slot 4 is validated in succession (step S80).

The host controller 9 may then issue a command to proceed with or cancel the current transaction (step S90), for example in response to a user pressing an appropriate key of an input device 26. If the host controller 9 issues the command to proceed, the validator controller 8 then controls the escrow 14 and a transport mechanism 19 to transfer any banknotes to a one-way cash box 20 which accumulates banknotes which are unsuitable for recirculation (step S100), and the deposit transaction is complete (step S110). The one-way cash box 20 may be emptied by an operator but its contents cannot be dispensed to a user.

Alternatively, the host controller 9 may issue a command to cancel the current transaction, for example in response to the user pressing another appropriate key of the input device 26. The current transaction may also be cancelled if the host controller 9 determines that a predetermined period has expired at step S90 without any further user input. The validator controller 8 controls the two-way cashbox 16 and a transfer mechanism 17 to transfer any banknotes stored during the current transaction to the escrow 14 (step S120) and then controls the escrow 14 and a dispensing mechanism 15 to transfer all its contents, including the banknotes previously stored in the escrow 14 and the banknotes transferred from the two-way cashbox 16, to a dispensing slot 22 (step S130). The deposit transaction is then ended (step S110).

The validator controller 8 records how many banknotes have been stored in the or each two-way cashbox 16 during the current transaction and dispenses the same number from the or each two-way cashbox 16 if the transaction is cancelled. When the current transaction ends (step S110), the validator controller 8 resets the recorded number of stored banknotes so that the number can be counted for a new transaction. Alternatively, the two-way cashbox 16 has an internal partition between banknotes deposited in the current transaction and banknotes stored from previous transactions; when the transaction is allowed to proceed (step S90), the partition and/or banknotes are moved so that the currently deposited banknotes are no longer separated from the banknotes stored in previous transactions.

A dispensing operation will now be described. If the apparatus is an automatic banking machine, a dispensing operation may be initiated by the user inserting a bank card and entering security details and an amount to be withdrawn in the input device 26. The host controller 9 may verify the security details via a remote connection (not shown) before commencing the dispensing operation. If the apparatus is a vending machine, the dispensing operation may be initiated to give change if the deposited amount is greater than the price of an item selected by the user.

In the dispensing operation, the host controller 8 determines the monetary amount to be dispensed and controls the or each two-way cashbox 16 to dispense banknotes to that amount. The banknotes may first be loaded into the escrow 14 and then transferred from the escrow 14 to the dispensing slot 22, as shown in FIG. 1. Alternatively, where a direct transport path is provided between the two-way cashbox 16 and the dispensing slot, the banknotes are dispensed directly to the dispensing slot 22. Banknotes may be dispensed from a one-way (dispensing only) cashbox instead of or as well as from the two-way cashbox 16.

In the alternative embodiment in which multiple denominations are stored in the same two-way cashbox, the cashbox 16 may allow random access to any banknote stored therein, and the validator controller 8 stores data representing the value and position of each banknote in the two-way cashbox 16. The validator controller 8 selects the required denominations for dispensing by controlling the position within the cashbox 16 from which each banknote is dispensed.

The dispensing slot 22 is shown schematically in FIG. 1 as being remote from the receiving slot 4 and reject slot 18, but is preferably physically proximate to, or even coterminous with either or both the other slots.

The banknotes returned from the two-way cashbox 16 if the current transaction is cancelled need not be the same as those stored therein during the current transaction, although this arrangement is preferred because it prevents exchange of undetected counterfeit notes for genuine notes. However, if the two-way cashbox 16 has a first-in first-out (FIFO) arrangement, banknotes may be returned from the two-way cashbox 16 to the value of those stored therein during the current transaction.

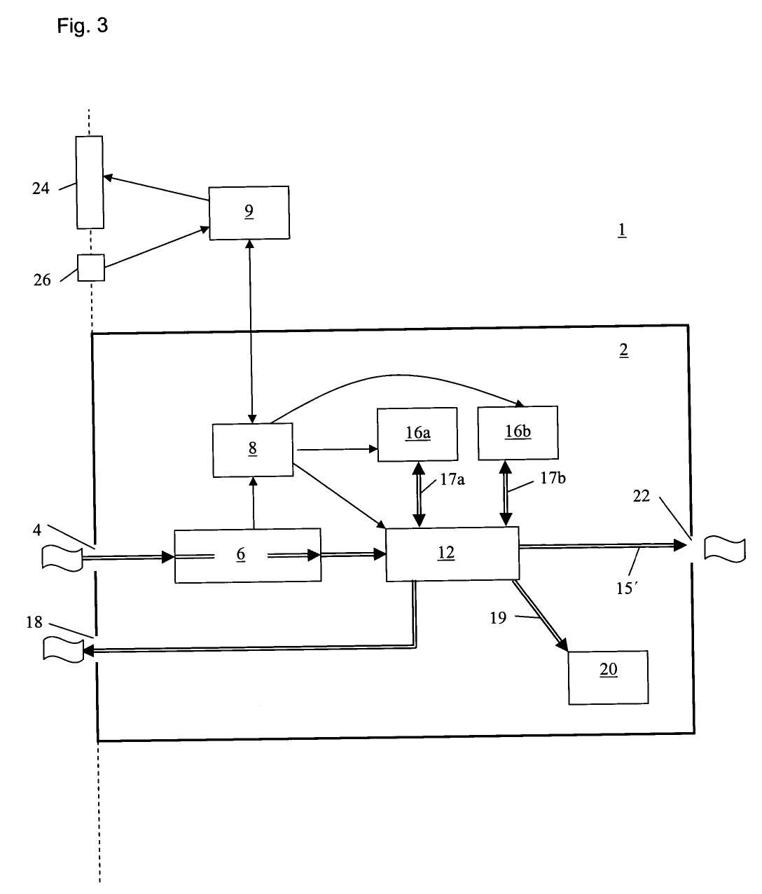

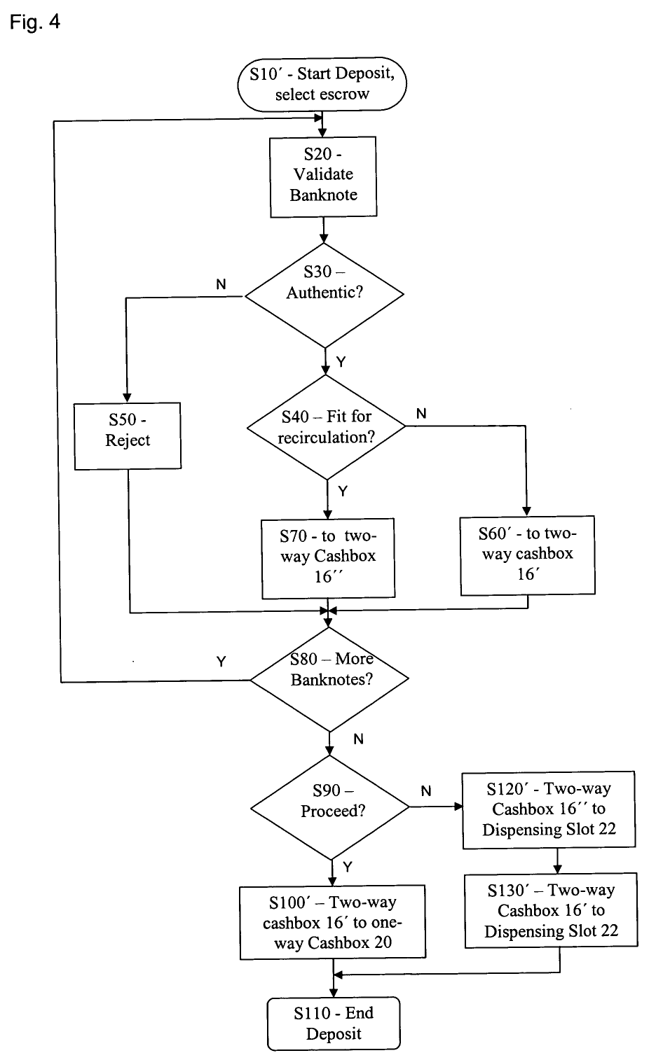

A second embodiment of the present invention will now be described with reference to FIGS. 3 and 4. The same reference numerals will be used to indicate parts similar to those of the first embodiment, and their description will not be repeated.

In the second embodiment, no separate escrow is provided for the temporary storage of notes which are judged unfit for recirculation; instead, one or more of a plurality of two-way stores 16a, 16b is used as an escrow for unfit notes, while another one or more of the two-way stores 16a, 16b is used to store fit notes in a similar way to the two-way cashbox 16 of the first embodiment. As in the first embodiment, ‘fit’ means ‘suitable for recirculation’, whether because of the condition or denomination of the banknote.

The same two-way store 16a, for example the one storing notes of the highest denomination, may be selected to function as an escrow for each transaction. Alternatively, the two-way store 16a, 16b selected to function as an escrow may vary between transactions, for example the one which has the least spare capacity for additional notes.

As shown in FIG. 3, the router 12 is arranged to route notes to and from each of the two-way stores 16a, 16b through corresponding transport mechanisms 17a, 17b, to the dispensing mechanism 15′, and to the one-way cashbox 20.

A method of operation of the second embodiment will now be described with reference to FIG. 4. At the start of the deposit in a new transaction, at step S10′, one of the two-way stores 16a, 16b is selected to act as the escrow according to a predetermined criterion, examples of which are described above. The method proceeds as in the first embodiment until the discrimination of notes according to condition at step S40. Unfit notes are routed to the two-way cashbox 16a selected as the escrow, at step S60′. Fit notes are routed to another two-way store 16b.

The method continues as in the first embodiment until the confirmation of whether or not the current transaction is to proceed, at step S90. If the transaction is to proceed, any unfit notes deposited in the two-way store 16a selected as the escrow are routed to the one-way cashbox 20, at step 100′. If the transaction is not to proceed, any unfit notes deposited in the two-way store 16a selected as the escrow are routed to the dispensing slot 22, at step S120′, and any fit notes stored in the other two-way store 16b are routed to the dispensing slot 22, at step S130′. In either case, the transaction then ends.

In a more specific example of the second embodiment, at least one of the two-way stores 16a, 16b is assigned to store a respective single denomination of notes, and fit notes are routed to a selected one of the two-way stores 16a, 16b according to their denomination, as detected at step S30.

In a first alternative, the two-way store 16a, 16b selected as the escrow in the current transaction is not also used to store fit notes received during that transaction for recirculation in subsequent transactions. As the selected two-way store 16a, 16b does not accumulate any notes at the end of the transaction, it is advantageous to select the two-way store 16a, 16b which has the least spare capacity. However, the two-way store 16a, 16b must have at least some spare capacity to be selected as an escrow. This alternative is particularly suitable for two-way stores 16a, 16b which operate on a last-in-first-out (LIFO) basis, where it is not easy to separate fit and unfit notes stored together in the same transaction.

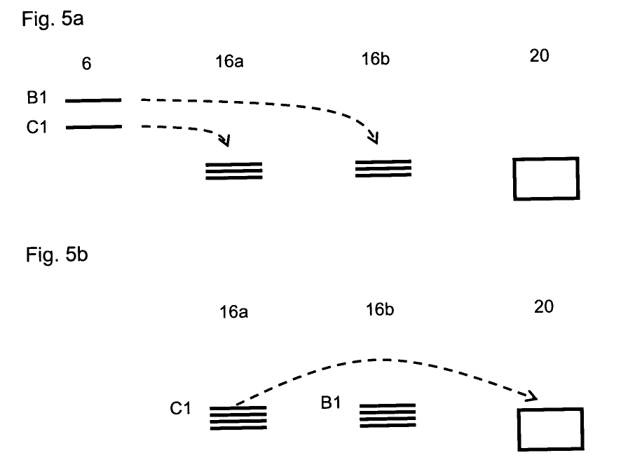

An example of the first alternative is illustrated schematically in FIGS. 5a and 5b. The two-way store 16a is selected to act as the escrow in this transaction, while the two-way store 16b acts as a store of fit notes of denomination B. As shown in FIG. 5a, a fit note B1 of denomination B is received from the validator 6 and stored in the two-way store 16b, while an unfit note C1 is stored in the two-way store 16a. If the transaction proceeds, then the note B1 remains in the two-way store 16b, and the note C1 is transferred to the one-way cashbox 20, as shown in FIG. 5b. If the transaction is cancelled, then the notes B1 and C1 are sent to the dispensing slot 22.

In a second alternative, the two-way store 16a, 16b selected as the escrow in the current transaction may also be used to store fit notes received in the same transaction, for example fit notes of the denomination stored between transactions by the selected two-way store 16a, 16b. This alternative is particularly suitable for two-way stores 16a, 16b which allow random access to notes stored during the current transaction. However, this alternative may be used with LIFO two-way stores 16a, 16b, in which case one or more of the other two-way stores 16a, 16b may be used as temporary stores for the fit notes when the transaction is confirmed.

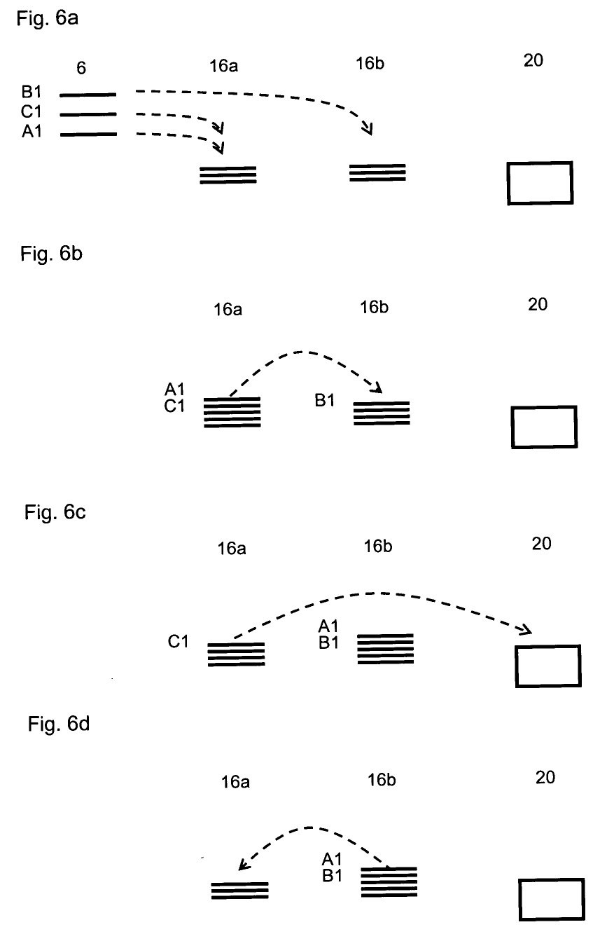

An example of the second alternative when applied to LIFO stores is shown in FIGS. 6a to 6d. The two-way store 16a is selected to act as the escrow in this transaction and also stores fit notes of denomination A, while the two-way store 16b acts as a store for fit notes of denomination B. The validator 6 validates in sequence fit note B1 of denomination B, unfit note C1 and fit note A1 of denomination A, which are routed respectively to the two-way stores 16b, 16a and 16a, as shown in FIG. 6a. If the transaction is cancelled, then the notes A1, B1 and C1 are sent to the dispensing slot 22. If however the transaction is confirmed, then the note A1 is first transferred to the two-way store 16b as shown in FIG. 6b, so as to enable the note C1 to be removed. Next, the note C1 is transferred to the one-way cashbox 20 as shown in FIG. 6c. Finally, the note A1 is returned from the two-way cashbox 16 to the two-way cashbox 16a where it is stored for possible recirculation in subsequent transactions.

In a third alternative, at least one of the two-way stores is selected as the escrow and stores fit notes of a first denomination between transactions and at least another one of the two-way stores is used as a temporary store for fit notes of the first denomination and stores fit notes of a second denomination different from the first denomination between transactions.

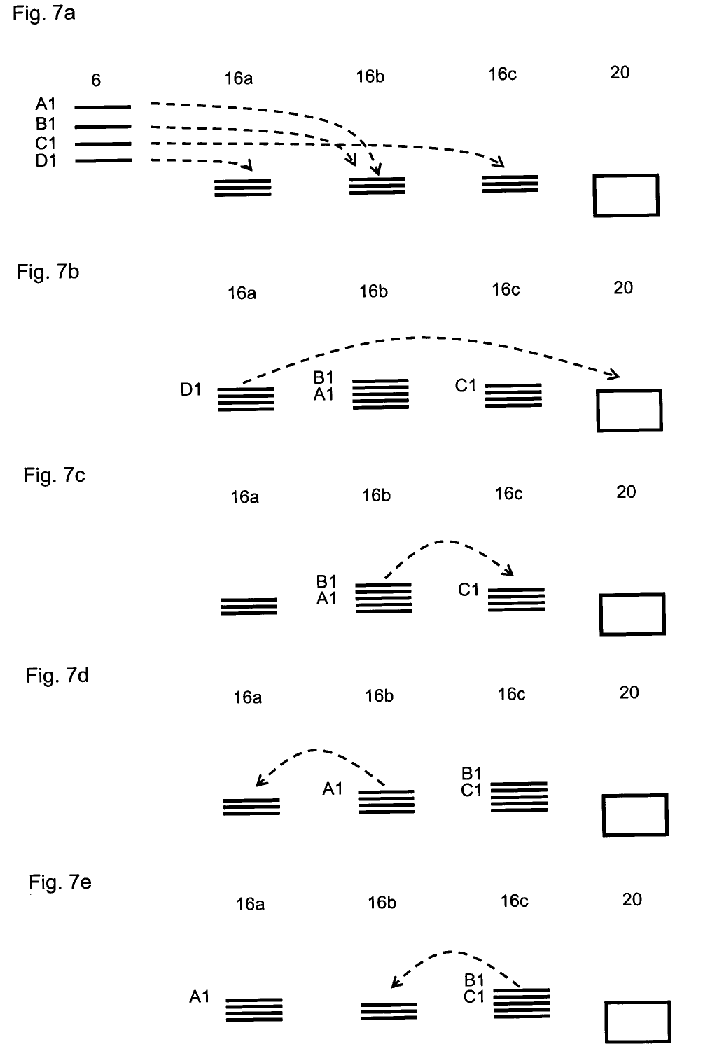

An example of the third alternative is shown in FIGS. 7a to 7e. The two-way store 16a is selected to act as the escrow in this transaction and also stores fit notes of denomination A, the two-way store 16b acts as a store for fit notes of denomination B and as a temporary store of notes of denomination A, and a two-way store 16c acts as a temporary store only if the transaction is confirmed, and as a store for fit notes of denomination C. The validator 6 validates in sequence fit note A1 of denomination A, fit note B1 of denomination B, fit note C1 of denomination C and unfit note D1 which are routed respectively to the two-way stores 16b, 16b, 16c and 16a, as shown in FIG. 7a. If the transaction is cancelled, then the notes A1, B1, C1 and D1 are sent to the dispensing slot 22. However, if the transaction is confirmed, then the unfit note D1 is first transferred to the one-way cashbox 20 as shown in FIG. 7b. Next, the note B1 is transferred to the two-way store 16c so as to make the note A1 available, as shown in FIG. 7c. Next, the note A1 is transferred to the two-way store 16a, as shown in FIG. 7d. Finally, the note B1 is transferred to the two-way store 16b, as shown in FIG. 7e.

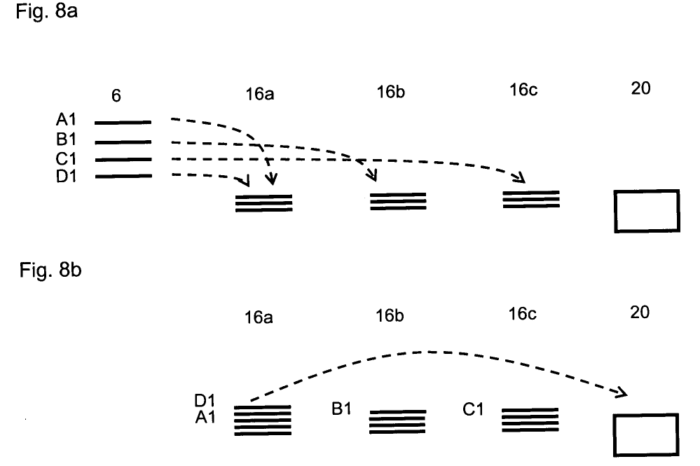

By way of comparison, the second alternative when applied to the above example is shown in FIGS. 8a and 8b. As the note A1 arrives before the unfit note D1, the note A1 remains in the two-way store 16a and all that is needed, as shown in FIG. 8b, is for the note D1 to be transferred to the one-way cashbox 20.

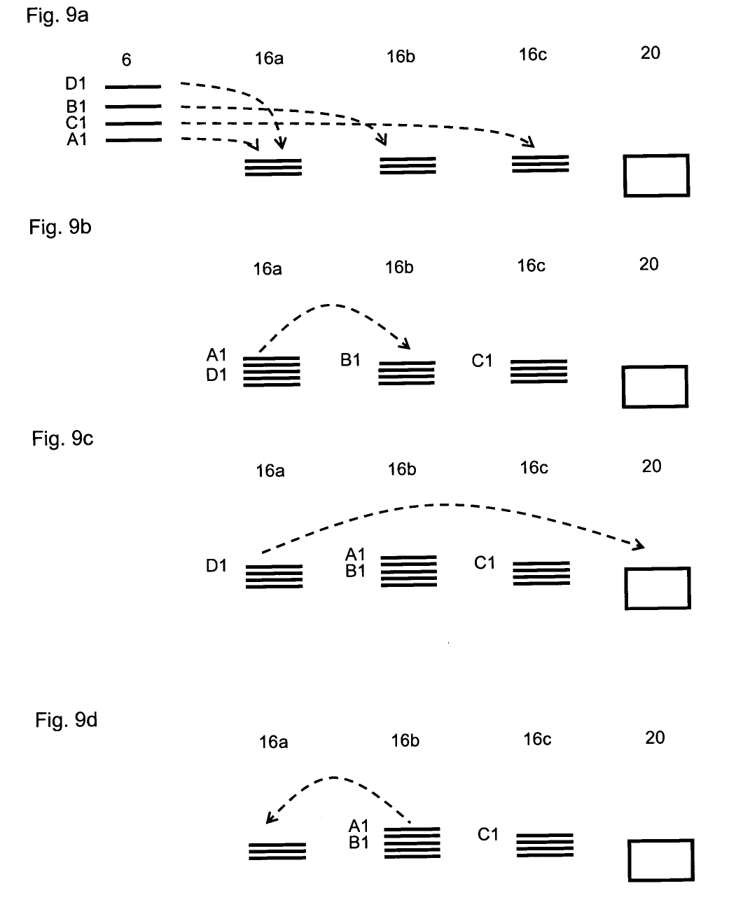

If the note D1 arrives before the note A1, in the example shown in FIG. 9a, and the transaction is confirmed, the note A1 is transferred temporarily to another two-way store, such as 16b, as shown in FIG. 9b; the note D1 is then transferred to the one-way cashbox 20, as shown in FIG. 9c, and the note A1 is then returned to the two-way store 16a, as shown in FIG. 9d.

Hence, in most circumstances the second alternative is preferable to the third alternative, because the latter results in fit notes on the ‘wrong’ denomination being placed in a LIFO store behind notes of the ‘right’ denomination (e.g. note A1 behind note B1 in the store 16b in FIGS. 7a to 7e). This may be avoided by not allowing the temporary store to store any fit notes of the ‘right’ denomination between transactions, but the capacity of the temporary store is then wasted. In contrast, the second alternative only results in unfit notes being placed behind fit notes of the ‘right’ denomination in the escrow. The fit notes can then be placed in the temporary store while the unfit notes are removed to the one-way store.

The second alternative results in at least one of the two-way stores other than the escrow being used as a temporary store only after the transaction is confirmed, while the third alternative results in at least one of the two-way stores other than the escrow being used as a temporary store before the transaction is confirmed, and at least one other of the two-way stores other than the escrow being used as a temporary store after the transaction is confirmed. Hence, the third alternative uses at least one more two-way store as a temporary store.

In the second embodiment, more than one two-way store 16a, 16b may be selected as an escrow in the same transaction. For example, one selected two-way store 16a, 16b may become full during the depositing stage of a transaction, and another two-way store 16a, 16b may then be selected as the escrow for further deposits. During cancellation or confirmation of the transaction, the unfit notes are then routed from all of the two-way stores selected as escrows during the current transaction.

Where more than one two-way store 16a, 16b is used as an escrow in the same transaction, one of the escrows may be used for notes which are unfit because in poor condition, while another may be used for notes which are unfit because of a denomination unsuitable for recirculation. This arrangement is particularly advantageous where different one-way stores 20 are provided for notes in poor condition and notes of a denomination unsuitable for recirculation.

A dispensing operation in the second embodiment proceeds as in the first embodiment, except that the dispensed notes are not held in a separate escrow prior to dispensing, but are dispensed directly from the two-way stores 16a, 16b to the dispensing slot 22. Hence, the two-way stores 16a, 16b may act as escrows while storing value carriers received during previous transactions during a depositing transaction, and may then dispense some or all of the previously received value carriers during a subsequent dispensing operation. Thus, the same two-way store 16a; 16b can act as an escrow in a depositing operation where an escrow is needed, and can also act as a dispensing store in a dispensing operation where no escrow is needed.

In either of the above embodiments, at least some of the banknotes in the two-way stores 16, 16a, 16b may have been loaded by an operator prior to the current transaction instead of being received from a user during a previous transaction. This may be done to ensure that enough banknotes are available for dispensing in future transactions.

In either of the above embodiments, banknotes judged to be forgeries may be stored in a separate one-way store rather than being returned to the reject slot 18; this is a legal requirement in some countries. A receipt may be printed and issued to the user.

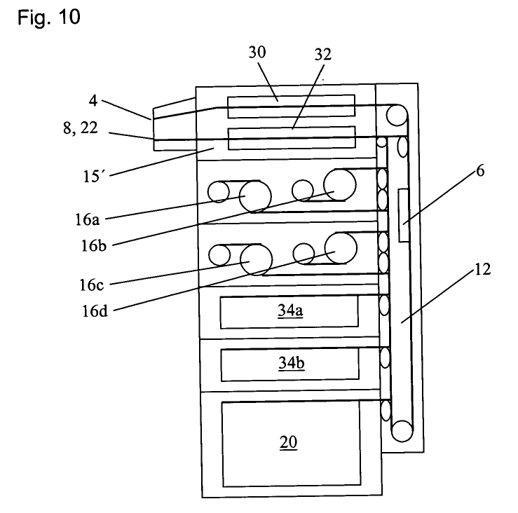

A more specific example of an apparatus according to the second embodiment will now be described with reference to FIG. 10, which shows a cross-section of a banknote changer, with transport paths shown by thick lines. In a receiving operation, banknotes received in the receiving slot 4 are aligned in a note alignment section 30 and then pass into the router 12 which is able to carry notes bi-directionally by means of an arrangement of belts and rollers. The banknotes pass through the validator 6 and each banknote is the selectively routed to the one-way cashbox 20, any one of four two-way stores 16a, 16b, 16c, 16d or the reject slot 8, which in this case is also used as the dispensing slot 22.

In a dispensing operation, one or more banknotes may be selectively dispensed from any of the four two-way stores 16a, 16b, 16c, 16d or two payout stores 34a, 34b which are pre-loaded with banknotes by an operator and are not able to store banknotes received in a receiving operation during a transaction. The dispensed banknotes are routed by the router 12 to the dispensing mechanism 15′, where they are collected in a bundler 32 and dispensed as a bundle through the dispensing slot 22.

The router 12 is able to transport banknotes one-by-one between any of the two-way stores, thus enabling the various alternatives described above with reference to the second embodiment.

The two-way stores 16a, 16b, 16c, 16d in this example are drum recyclers of well-known type.

Although the above embodiments have been described with reference to banknotes, the present invention is also applicable to other types of value carrier, such as tokens, certificates, coins and the like.

Although the above embodiments include an authenticity test as well as a test for condition, the authenticity test may not be necessary in applications where the authenticity of the value carriers is not in doubt, such as where the apparatus is intended for use by bank staff only.

The controller may be programmed with software to control the operations described in the embodiments. The software may be stored on a carrier, such as a disk or ROM, and/or downloaded as a data signal over a communications medium.

1. A method of receiving and storing value carriers, comprising
a. initiating (S10′) a current transaction;
b. storing (S60′) a currently received value carrier, received during the current transaction, in a first store (16a) which contains at least one previously received value carrier received in a previous transaction; and
c. completing (S100′, S110) the current transaction;
characterised in that step c includes transferring (S100′) the currently received value carrier from the first store (16a) to a second store (16b; 20).

2. A method according to claim 1, including determining (S40) the suitability for recirculation of the currently received value carrier, wherein step b is performed in response to a determination that the currently received value carrier is unsuitable for recirculation.

3. A method according to claim 2, wherein step b is performed in response to a determination that the currently received value carrier is in poor condition.

4. A method according to claim 2, wherein step b is performed in response to a determination that the currently received value carrier is of a predetermined denomination.

5. A method according to claim 4, wherein the at least one previously received value carrier is of the predetermined denomination.

6. A method according to any preceding claim, wherein said second store is a one-way store (20) from which the currently received value carrier cannot be dispensed.

7. A method according to claim 1, including determining the denomination of said currently received value carrier, wherein step b is performed in response to a determination that the currently received value carrier is of a predetermined denomination.

8. A method according to claim 7, wherein the second store (16b) is a two-way store.

9. A method according to claim 8, wherein step c further includes transferring the currently received value carrier from the second store (16b) back to the first store (16a).

10. A method according to any one of claims 7 to 9, wherein said at least one previously received value carrier is of the predetermined denomination.

11. A method according to any one of claims 7 to 10, wherein the second store (16b) contains at least one value carrier of a different denomination to said predetermined denomination.

12. A method according to any one of claims 7 to 11, wherein step b includes transferring an other value carrier received during the current transaction to the first store (16a) in response to a determination that the other value carrier is unsuitable for recirculation, and step c includes transferring the other value carrier from the first store (16a) to a third store (20) from which value carriers cannot be dispensed.

13. A method according to any one of claims 8 to 12, wherein the first store (16a) is a last-in first-out store.

14. A method according to any preceding claim, including, in a previous transaction prior to step a, receiving said at least one previously received value carrier and storing the previously received value carrier in the first store (16a).

15. A method according to any one of claims 1 to 13, wherein the previously received value carrier is loaded into the first store (16a) prior to step a.

16. A method according to any preceding claim, wherein the currently received value carrier is dispensed if the current transaction is cancelled.

17. A method according to any preceding claim, wherein the currently received value carrier is transferred singly without any other value carrier.

18. A method of receiving and storing value carriers, in which a store (16a; 16b) is used to store value carriers of only one denomination between transactions; characterised in that the store (16a; 16b) is used as a temporary store for a value carrier of another denomination during a transaction.

19. A method of receiving, validating and dispensing value carriers in first and second discrete transactions, wherein a two-way store (16a; 16b) is used in a first transaction as an escrow for value carriers judged unsuitable for recirculation and is used in a second transaction as a store for value carriers judged suitable for recirculation.

20. A method according to claim 19, wherein the two-way store (16a; 16b) is also used in the first transaction to store value carriers judged suitable for recirculation.

21. A method according to claim 20, wherein the two-way store (16a; 16b) is used in the first transaction, before the transaction is confirmed, to store said value carriers judged suitable for recirculation.

22. A method according to claim 20, wherein the two-way store (16a; 16b) is used in the first transaction, after the transaction is confirmed, to store said value carriers judged suitable for recirculation.

23. A method according to any one of claims 19 to 22, wherein the two-way store is not also used, in the second transaction, as an escrow for value carriers judged unsuitable for recirculation.

24. A method according to any one of claims 19 to 23, wherein at least one further two-way store (16b; 16a) is used in the first transaction as a store for value carriers judged suitable for recirculation and in the second transaction as an escrow for value carriers judged unsuitable for recirculation.

25. A method of receiving, validating and dispensing value carriers in a plurality of discrete transactions, wherein a plurality of two-way stores (16a, 16b) are provided for storing received value carriers, a selected one (16a) or more of the two-way stores is used as an escrow for value carriers judged unsuitable for recirculation and a non-selected one (16b) or more of the two-way stores are used as a store for value carriers judged suitable for recirculation, characterised in that the selection of the one or more two-way stores varies between transactions.

26. A method according to claim 25, wherein at least one (16a) of the selected two-way stores is selected on the basis of having a spare capacity less than that of at least one (16b) of the non-selected two-way stores.

27. A method of receiving, validating and dispensing value carriers, wherein a transaction is initiated (S10; S10′), received value carriers are validated for recirculation (S40) and received value carriers which are judged not suitable for recirculation are stored (S60; S60′) in an escrow (14; 16a) and, if the current transaction is cancelled (S90), are dispensed (S130; S130′) from the escrow (14; 16a); characterised in that at least some of the received value carriers judged suitable for recirculation are stored (S70) in a two-way store (16; 16b) together with other value carriers received in previous transactions and, if the current transaction is cancelled (S90), value carriers are dispensed (S120, S130; S130′) from the two-way store (16; 16b).

28. A method according to claim 27, wherein the value carriers dispensed from the two-way store (16; 16b) if the current transaction is cancelled are those received in the current transaction.

29. A method according to claim 27, wherein the value carriers dispensed from the two-way store (16; 16b) if the current transaction is cancelled are different from, but of the same total value as, those received during the current transaction.

30. A method according to any one of claims 27 to 29, wherein, if the current transaction is cancelled (S90), the received value carriers suitable for recirculation are transferred (S120) from the two-way store (16) to the escrow (14) prior to being dispensed (S130).

31. A method according to any one of claims 27 to 30, wherein, if the current transaction proceeds (S90) and the value of the deposited value carriers is greater than required for the current transaction, value carriers are transferred to the escrow (14) and dispensed as change.

32. A method according to any one of claims 27 to 29, wherein the escrow (16a) stores other value carriers received in previous transactions.

33. A method according to any one of claims 27 to 29 and 32, wherein others of the value carriers judged suitable for recirculation are stored in the escrow (16a).

34. A method according to claim 33, wherein the received value carriers are validated for denomination, and the value carriers judged suitable for recirculation are stored in the two-way store (16b) or the escrow (16a) according to their denomination.

35. A method according to any one of claims 27 to 34, wherein, if the current transaction proceeds (S90), the received value carriers stored in the escrow (14; 16a) are transferred (S100; S100) to a one-way store (20).

36. A method according to any one of claims 27 to 34, wherein the received value carriers are validated for authenticity (S30) and those judged not authentic are dispensed (S50) without being stored.

37. A method according to any one of claims 27 to 34, wherein the received value carriers are validated for authenticity (S30) and those judged not authentic are stored in a further one-way store.

38. A method according to any preceding claim, wherein the value carriers are banknotes or the like.

39. Apparatus arranged to perform a method according to any preceding claim.

40. A computer program arranged to perform the method according to any one of claims 1 to 38 when executed by suitable hardware.

41. A carrier carrying a computer program according to claim 40.

42. Apparatus for receiving and storing value carriers, comprising:
a first store (16a) which stores at least one previously received value carrier received during a previous transaction;
a second store (16b; 20);
a router (12) for routing received value carriers to and from the first store (16a) and to the second store (16b; 20); and
a controller (8) arranged to control the router (12) and responsive to a first signal to initiate a current transaction and to a second signal to complete the current transaction;
characterised in that the controller (8) is arranged to control the router (12) to route a currently received value carrier received during the current transaction to the first store (16a) and subsequently, in response to the second signal, to route the currently received value carrier from the first store (16a) to the second store (16b; 20).

43. Apparatus according to claim 42, further including a validator (6), wherein the controller (8) is arranged to control the router (12) to route the currently received value carrier to the first store (16a) in response to a validation determination by the validator (6).

44. Apparatus according to claim 43, wherein the validator (6) is arranged to determine the suitability for recirculation of the currently received value carrier, and the validation determination is a determination that the currently received value carrier is unsuitable for recirculation.

45. Apparatus according to claim 43, wherein the validator (6) is arranged to determine the denomination of the currently received value carrier, and the validation determination is a determination that the currently received value carrier is of a specified denomination.

46. Apparatus according to any one of claims 42 to 44, wherein the second store is a one-way store (20) from which value carriers cannot be dispensed.

47. Apparatus according to any one of claims 42 to 44, wherein the second store is a two-way store (16b) from which value carriers can be dispensed.

48. Apparatus for receiving, validating and dispensing value carriers, including:
a validator (6) for validating value carriers according to their suitability for recirculation;
an escrow (14) arranged to store value carriers received from the validator (6);
a two-way store (16) arranged to store value carriers received from the validator;
a router (12) arranged selectively to route value carriers from the validator to the escrow (14) or the two-way store (16);
a transfer mechanism (17) for transferring value carriers from the two-way store (16) to the escrow (14);
a dispensing mechanism (15) for dispensing value carriers from the escrow (14); and a controller (8) arranged to control the router (12) to route those value carriers judged suitable for recirculation to the two-way store (16) and those value carriers judged not suitable for recirculation to the escrow (14).

49. Apparatus as claimed in claim 48, wherein the controller (8) is arranged, if a current transaction is cancelled, to control the transfer mechanism (17) to transfer value carriers from the two-way store (16) to the escrow (14), and subsequently to control the dispensing mechanism (15) to dispense value carriers from the escrow (14).

50. Apparatus as claimed in claim 48 or 49, further including a one-way store (20) and a transport mechanism (19) arranged to transport value carriers from the escrow (14) to the one-way store (20), the controller (8) being arranged to control the transport mechanism (19) to transport value carriers from the escrow (14) to the one-way store (20) if the current transaction is enabled to proceed.

51. Apparatus as claimed in any one of claims 48 to 50, wherein the two-way store (16) is arranged to store value carriers received during the current transaction together with value carriers received during previous transactions.
